(19) United States
(12) Patent Application Publication
(10) Pub. No.: US 2013/0006493 A1
(43) Pub. Date: Jan. 3, 2013

(54) DRIVING FORCE CONTROL APPARATUS AND DRIVING FORCE CONTROL METHOD FOR VEHICLE

(75) Inventors: Masashi Takagi, Nagoya-shi Aichi-ken (JP); Motonari Ohbayashi, Nisshin-shi Aichi-ken (JP); Yuki Minase, Toyota-shi Aichi-Ken (JP); Shinya Kodama, Toyota-shi Aichi-ken (JP); Toshihiro Takagi, Toyota-shi Aichi-ken (JP)

(73) Assignee: TOYOTA JIDOSHA KABUSHIKI KAISHA, Toyota-shi Aichi-ken (JP)

(21) Appl. No.: 13/536,264

(22) Filed: Jun. 28, 2012

(30) Foreign Application Priority Data
Jul. 1, 2011 (JP) 2011-147363

(51) Int. Cl. F02D 28/00

(52) U.S. Cl. 701/102

(57) ABSTRACT

A driving force control apparatus for a vehicle includes a driving force suppression processing unit and a control unit. The driving force suppression processing unit executes driving force suppression processing to set a driving force output from a prime mover below a driving force corresponding to an accelerator operation amount. The control unit modifies a driving farce output during execution of the driving force suppression processing in accordance with a steering angle of the vehicle.

### INCORPORATION BY REFERENCE

The disclosure of Japanese Patent Application No. 2011-147363 filed on Jul. 1, 2011, including the specification, drawings and abstract, is incorporated herein by reference in its entirety.

### BACKGROUND OF THE INVENTION

1. Field of the Invention

The invention relates to a driving force control apparatus and a driving force control method for a vehicle.

2. Description of Related Art

Japanese Patent Application Publication No. 61-190135 (JP-61-190135 A), for example, discloses a technique that can be used as a driving force control apparatus for a vehicle, in which driving force suppression processing is performed to reduce a driving force output from an engine below a driving force corresponding to an operation amount of an accelerator pedal when the accelerator pedal is depressed forcefully.

Incidentally, when a vehicle is steered from a state of forward advancement, a force acting in a vehicle reversing direction is generated by a component force of a lateral force acting on a steered wheel. The force that acts in the vehicle reversing direction during a vehicle turn will be referred to hereafter as cornering drag. Cornering drag acts as travel resistance on the vehicle during the vehicle turn, and as a result, the vehicle is decelerated.

An output of a prime mover may be controlled during execution of the aforesaid driving force suppression processing to ensure that sufficient driving force for maintaining vehicle travel is generated while suppressing excessive acceleration of the vehicle and so on. In this case, when the driving force suppression processing is executed without taking into account the vehicle deceleration caused by the cornering drag described above, the driving force may be increased in order to compensate for the vehicle deceleration caused by the cornering drag. This increase in driving force suppresses deceleration of the vehicle accompanying the steering operation, and as a result, a driver may experience an unpleasant sensation.

### SUMMARY OF THE INVENTION

The invention provides a driving force control apparatus and a driving force control method for a vehicle, with which an unpleasant sensation experienced by a driver during a steering operation is suppressed.

A driving force control apparatus for a vehicle according to a first aspect of the invention includes a driving force suppression processing unit and a control unit. The driving force suppression processing unit executes driving force suppression processing to set a driving force output from a prime mover below a driving force corresponding to an accelerator operation amount. The control unit modifies a driving force output during execution of the driving force suppression processing in accordance with a steering angle of the vehicle.

According to the first aspect, the driving force output during execution of the driving force suppression processing is modified in accordance with the steering angle. Hence, the driving force output during execution of the driving force suppression processing is modified when the cornering drag varies. In other words, when the driving force suppression processing is executed during a steering operation, the vehicle decelerates in accordance with the steering angle. Therefore, according to the first aspect, an unpleasant sensation experienced by the driver during the steering operation is suppressed.

A driving force control method for a vehicle according to a second aspect of the invention includes: executing driving force suppression processing to set a driving force output from a prime mover below a driving force corresponding to an accelerator operation amount; and modifying a driving force output during execution of the driving force suppression processing in accordance with a steering angle of the vehicle. According to the second aspect, similar effects to the first aspect are obtained.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a schematic view showing an overall configuration of an embodiment;

FIG. 2 is a schematic view showing cornering drag acting on a vehicle;

FIG. 3 is a flowchart showing processing procedures of a driving force suppression control routine according to this embodiment;

FIG. 4 is a graph showing a relationship between a vehicle speed and a target acceleration;

FIG. 5 is a graph showing modification of the target acceleration when cornering drag is generated; and

FIG. 6 is a graph showing a relationship between the vehicle speed and the target acceleration according to a third modified example of the embodiment.

### DETAILED DESCRIPTION OF EMBODIMENTS

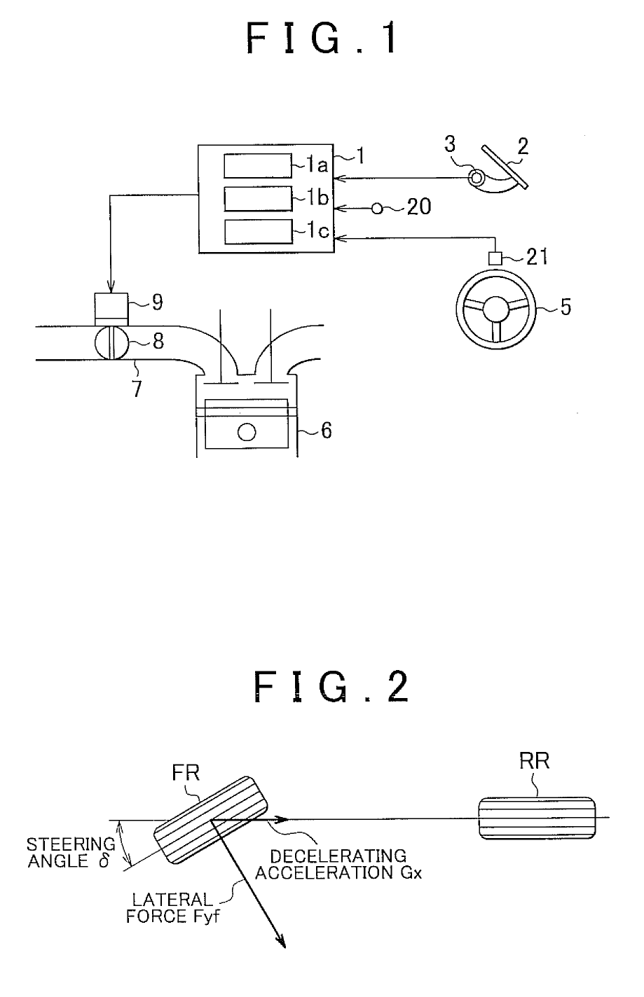

A driving force control apparatus for a vehicle according to an embodiment will be described below with reference to FIGS. 1 to 5. The driving force control apparatus according to this embodiment is applied to a vehicle that obtains a driving force from an output of an engine 6 serving as a prime mover.

As shown in FIG. 1, the driving force control apparatus for a vehicle according to this embodiment includes an in-vehicle electronic control unit 1. The electronic control unit 1 includes a central processing unit (CPU) 1a, a read-only memory (ROM) 1b, and a random access memory (RAM) 1c. The CPU 1a implements various types of calculation processing relating to vehicle control. The ROM 1b stores control programs and data. The RAM 1c temporarily stores calculation results from the CPU 1a and detection results from sensors.

Sensors and switches provided in respective parts of the vehicle are connected to the electronic control unit 1. An accelerator pedal sensor 3, a vehicle speed sensor 20, and a steering wheel angle sensor 21, for example, are connected as the sensors and switches. The accelerator pedal sensor 3 detects an accelerator operation amount ACCP, which is a depression amount of an accelerator pedal 2. The vehicle speed sensor 20 detects a speed (a vehicle speed V) of the vehicle. The steering wheel angle sensor 21 detects a steering wheel angle θ, which is a rotation angle of a steering wheel 5. The electronic control unit 1 calculates a steering angle δ of a steered wheel of the vehicle on the basis of a steering gear ratio of a steering apparatus and the steering wheel angle θ.

Actuators provided in respective parts of the vehicle are also connected to the electronic control unit 1. The actuators include a throttle motor 9 provided in an intake passage 7 of the engine 6, for example. The throttle motor 9 drives a throttle valve 8 used to adjust the engine output.

The electronic control unit 1 determines an operating condition of the vehicle from detection results obtained from the respective sensors and switches. The electronic control unit 1 then controls the vehicle by outputting command signals to the respective actuators in accordance with the determined operating condition of the vehicle. For example, the electronic control unit 1 adjusts the driving force output from the engine 6 by controlling an opening of the throttle valve 8 in accordance with the accelerator operation amount ACCP.

The electronic control unit 1 determines whether or not the accelerator operation amount ACCP satisfies a predetermined condition. The predetermined condition is a condition for determining whether or not the accelerator pedal 2 has been depressed forcefully. When it is determined that the predetermined condition is satisfied, the driving force output from the engine 6 is set below a driving force corresponding to the accelerator operation amount ACCP. Control for setting the driving force output from the engine 6 below the driving force corresponding to the accelerator operation amount ACCP will be referred to hereafter as driving force suppression processing. As a result of the driving force suppression processing, excessive acceleration of the vehicle and the like are suppressed.

In this embodiment, an acceleration of the vehicle is feedback-controlled such that an actual acceleration KA of the vehicle during execution of the driving force suppression processing reaches a target acceleration KAp. Specifically, the driving force is adjusted on the basis of a deviation ΔKA between the acceleration KA and the target acceleration KAp. As a result of this feedback control, the output of the engine 6 is controlled during execution of the driving force suppression processing such that sufficient driving force is generated to allow the vehicle to travel while suppressing excessive acceleration of the vehicle and the like.

As shown in FIG. 2, when the steering wheel 5 is operated such that the steering angle δ is generated in a front wheel FR, a component force of a lateral force Fyf acting on the front wheel FR is generated in a vehicle reversing direction. This component force generated in the vehicle reversing direction during steering of the vehicle is available as cornering drag. The cornering drag is calculated from sin δ×Fyf. As is evident from this equation, the cornering drag increases with increases in the steering angle δ and the lateral force Fyf.

The lateral force Fyf is caused by centrifugal force acting on the vehicle, and may therefore be determined mechanically from a rotary angular velocity of the turning vehicle and a mass (weight) of the vehicle. In this embodiment, the lateral force Fyf is estimated using the steering wheel angle θ related to the front wheel FR corresponding to the steering angle δ and the vehicle speed V instead of the rotary angular velocity of the turning vehicle. Note that the lateral force Fyf takes a steadily larger value as the steering wheel angle θ or the vehicle speed V increases.

The cornering drag acts on the vehicle as a deceleration force. Vehicle reversing direction acceleration (to be referred to hereafter as decelerating acceleration) Gx caused by the cornering drag is calculated by dividing “sin δ×Fyf” by a mass M of the vehicle. Hence, the decelerating acceleration Gx caused by the cornering drag generated during a steering operation is calculated using Equation (1) below.

Gx=(sin Δ×Fyf)/M (1)

When cornering drag is generated in this manner during a steering operation, the vehicle is decelerated by the decelerating acceleration Gx. In certain cases, therefore, the acceleration KA of the vehicle during execution of the driving force suppression processing may fall below the target acceleration KAp. When the acceleration of the vehicle is feedback-controlled as described above, the driving force is increased in order to reduce the deviation ΔKA between the acceleration KA and the target acceleration KAp. When the driving force is increased, vehicle deceleration accompanying the steering operation is suppressed, and as a result, the driver may experience an unpleasant sensation.

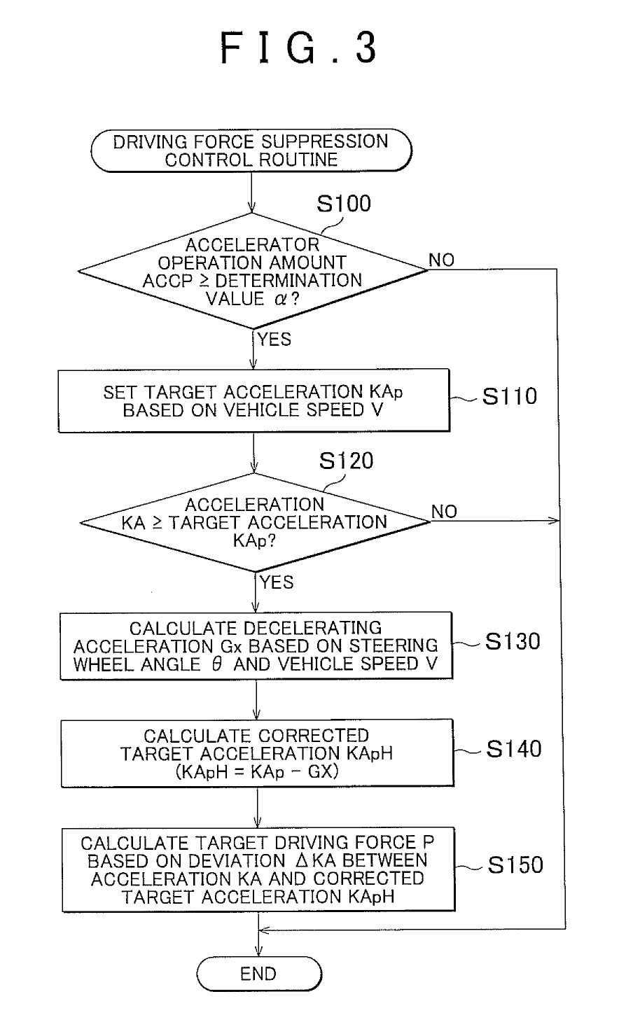

Hence, in this embodiment, the unpleasant sensation experienced by the driver during a steering operation is suppressed by performing the driving force suppression processing while taking into account deceleration caused by the cornering drag. FIG. 3 shows processing procedures of a driving force suppression control routine according to this embodiment. Note that this routine is executed repeatedly at predetermined period intervals by the electronic control unit 1.

When the routine is started, first, a determination is made as to whether or not the accelerator operation amount ACCP equals or exceeds a determination value a (S100). When the accelerator operation amount ACCP is smaller than the determination value α (S100: NO), the routine is temporarily terminated.

When the accelerator operation amount ACCP equals or exceeds the determination value α(S100: YES), on the other hand, it is determined that the accelerator pedal 2 has been depressed forcefully, and therefore processing of Step S110 onward is performed.

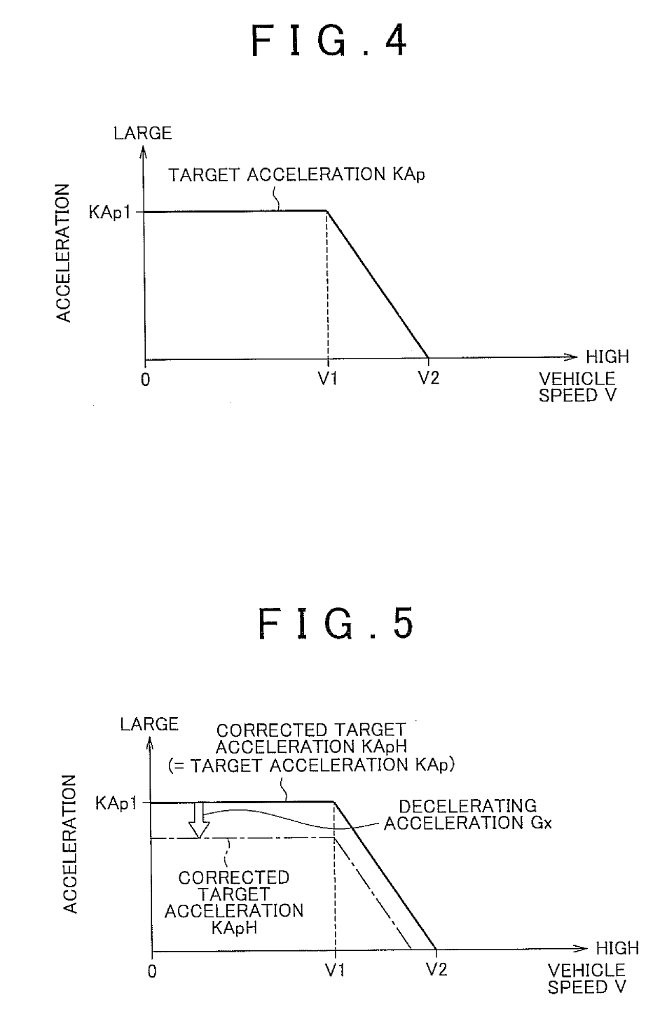

In Step S110, the target acceleration KAp of the vehicle is set on the basis of the vehicle speed V. Here, as shown in FIG. 4, when the vehicle speed V is lower than a first vehicle speed V1, the target acceleration KAp is set at a predetermined fixed value KAp1. When the vehicle speed V is no lower than the first vehicle speed V1 and lower than a second vehicle speed V2, the target acceleration KAp is reduced gradually from the fixed value KAp1 as the vehicle speed V increases. The second vehicle speed V2 is set at a higher value than the first vehicle speed V1. Therefore, when the vehicle speed V exceeds the first vehicle speed V1, the vehicle speed increases more gently. Further, when the vehicle speed V equals or exceeds the second vehicle speed V2, the target acceleration KAp is set at “0”. Hence, when the vehicle speed V reaches the second vehicle speed V2, the vehicle speed V is maintained at the second vehicle speed V2.

Next, a determination is made as to whether or not the actual acceleration KA of the vehicle equals or exceeds the target acceleration KAp (S120). Note that the acceleration KA is determined from a differential value of the vehicle speed V. When the acceleration KA is lower than the target acceleration KAp (S120: NO), the routine is temporarily terminated.

When the acceleration KA equals or exceeds the target acceleration KAp (S120: YES), on the other hand, the driving force suppression processing is performed from Step S130 onward. First, in Step S130, the decelerating acceleration Gx generated by the cornering drag is calculated on the basis of the steering wheel angle θ and the vehicle speed V using Equation (1). As is evident from Equation (1), the decelerating acceleration Gx takes a steadily larger value as the steering angle δ increases.

Next, a corrected target acceleration KApH is calculated (S140). Here, a value obtained by subtracting the decelerating acceleration Gx from the target acceleration KAp set in Step S110 is set as the corrected target acceleration KApH. As shown in FIG. 5, therefore, when the steering wheel angle θ is “0”, as indicated by a solid line, the target acceleration KAp set in Step S110 is set as is as the corrected target acceleration KApH.

When, on the other hand, the steering wheel angle θ takes a value other than “0”, as shown by a dot-dash line in FIG. 5, a value obtained by subtracting the decelerating acceleration Gx from the target acceleration KAp set in Step S110 is set as the corrected target acceleration KApH. In other words, the corrected target acceleration KApH is set at a value which is smaller than the target acceleration KAp by the decelerating acceleration Gx.

Next, in Step S150, a target driving force P is calculated on the basis of the deviation ΔKA (=KA−KapH) between the acceleration KA and the corrected target acceleration KApH. The target driving force P is a value calculated by performing feedback control on the basis of the deviation ΔKA. In other words, the target driving force P is set in accordance with the magnitude of the deviation ΔKA. When the target driving force P has been calculated in this manner, the routine is temporarily terminated. The output of the engine 6 is then controlled to obtain the target driving force P.

Next, actions of this embodiment will be described. When the accelerator operation amount ACCP equals or exceeds the determination value α and the acceleration KA of the vehicle equals or exceeds the target acceleration KAp, the driving force suppression processing is executed to suppress the driving force output from the engine 6. The driving force output during execution of the driving force suppression processing is then modified in accordance with the steering angle δ.

More specifically, the target acceleration KAp is calculated on the basis of the vehicle speed V. Further, the decelerating acceleration Gx that decelerates the vehicle is calculated on the basis of the steering angle δ (the steering wheel angle θ). The corrected target acceleration KApH is then calculated by subtracting the decelerating acceleration Gx from the target acceleration KAp. Further, the target driving force P to be output during execution of the driving force suppression processing is calculated on the basis of the deviation ΔKA between the corrected target acceleration KApH and the actual acceleration KA of the vehicle.

Hence, the acceleration KA of the vehicle during execution of the driving force suppression processing is feedback-controlled to the corrected target acceleration KApH. As described above, the steering angle δ has a correlative relationship with the magnitude of the cornering drag that decelerates the vehicle. In this embodiment, therefore, the decelerating acceleration Gx that decelerates the vehicle is calculated on the basis of the steering angle δ. Further, the final corrected target acceleration KApH is calculated by subtracting the decelerating acceleration Gx from the target acceleration KAp. As a result, the target acceleration KAp is corrected appropriately in accordance with the magnitude of the cornering drag.

By calculating the corrected target acceleration KApH in this manner, the driving force output during execution of the driving force suppression processing is modified in accordance with the steering angle δ. More specifically, as the steering angle δ increases, the value of the decelerating acceleration Gx increases, and accordingly the value of the set corrected target acceleration KApH decreases. When the value of the corrected target acceleration KApH decreases in this manner, the deviation ΔKA between the corrected target acceleration KApH and the acceleration KA of the vehicle decelerated by the steering operation decreases, and therefore the target driving force P to be output during execution of the driving force suppression processing is reduced. Hence, an increase in driving force during the steering operation is suppressed, and as a result, the unpleasant sensation experienced by the driver during the steering operation is suppressed.

Further, the processing of Step S130 onward in FIG. 3, or in other words the driving force suppression processing, is executed when the accelerator operation amount ACCP equals or exceeds the determination value α (S100: YES) and the acceleration KA of the vehicle equals or exceeds the target acceleration KAp (S120: YES). Therefore, even when the accelerator pedal 2 is depressed forcefully while the accelerator operation amount ACCP equals or exceeds the determination value cc the driving force suppression processing is not executed unless the acceleration KA of the vehicle satisfies the target acceleration KAp. Accordingly, acceleration corresponding to the accelerator operation amount ACCP generated by the driver of the vehicle is obtained. Hence, the driver is permitted to adjust the acceleration of the vehicle to a certain extent, and as a result, an improvement in drivability is achieved.

Further, as shown in FIG. 4, when the vehicle speed V exceeds the first vehicle speed V1 during execution of the driving force suppression processing, the target acceleration KAp is gradually reduced. Accordingly, the corrected target acceleration KApH is likewise gradually reduced as the vehicle speed V increases. As a result, the driving force is suppressed such that the acceleration KA of the vehicle decreases gradually. Hence, as the vehicle speed increases due to an accelerator operation, an increase rate of the vehicle speed is suppressed, and therefore an increase in the vehicle speed V when the accelerator operation amount ACCP equals or exceeds the determination value α is suppressed.

A first effect of this embodiment will be described below. In this embodiment, the driving force output during execution of the driving force suppression processing is modified in accordance with the steering angle δ of the vehicle. Therefore, the driving force output while the driving force suppression processing is executed during a steering operation is reduced in accordance with the magnitude of the cornering drag. Hence, when the driving force suppression processing is executed during the steering operation, the vehicle is decelerated in accordance with the steering angle δ, and as a result, the unpleasant sensation experienced by the driver during the steering operation is suppressed.

A second effect of this embodiment will be described below. In this embodiment, the target driving force P to be output during execution of the driving force suppression processing is reduced as the steering angle δ increases, and therefore the unpleasant sensation experienced by the driver during the steering operation is suppressed favorably.

A third effect of this embodiment will be described below. In this embodiment, the driving force suppression processing is executed when the accelerator operation amount ACCP equals or exceeds the determination value α and the acceleration KA of the vehicle equals or exceeds the target acceleration KAp. Hence, the driver is permitted to adjust the acceleration of the vehicle to a certain extent, and as a result, an improvement in drivability is achieved.

A fourth effect of this embodiment will be described below. In this embodiment, the driving force is suppressed during execution of the driving force suppression processing such that the acceleration KA of the vehicle decreases as the vehicle speed V increases. Therefore, an increase in the vehicle speed V when the accelerator operation amount ACCP equals or exceeds the determination value α is suppressed.

A fifth effect of this embodiment will be described below. In this embodiment, the target acceleration KAp is calculated on the basis of the vehicle speed V, and the decelerating acceleration Gx that decelerates the vehicle is calculated on the basis of the steering angle δ. Further, the target driving force P to be output during the driving force suppression processing is calculated on the basis of the deviation ΔKA between the value obtained by subtracting the decelerating acceleration GX from the target acceleration KAp and the actual acceleration KA of the vehicle. As a result, the target acceleration KAp is corrected appropriately in accordance with the magnitude of the cornering drag.

Note that the embodiment described above may be implemented after performing following modifications. A first modified example of the embodiment will be described below. In the above embodiment, a determination is made as to whether or not the accelerator pedal 2 has been depressed forcefully in order to determine whether or not to execute the driving force suppression processing. During this determination, the accelerator operation amount ACCP is compared with the determination value α. According to the first modified example, on the other hand, a determination may be made as to whether or not the accelerator operation amount satisfies a predetermined condition. For example, a condition according to which an accelerator operation amount per unit time exceeds a predetermined value, or in other words a variation speed of the accelerator operation amount exceeds a predetermined value, may be set. Alternatively, a condition according to which a variation speed of the accelerator operation amount per unit time exceeds a predetermined value, or in other words a variation acceleration of the accelerator operation amount exceeds a predetermined value, or the like may be set.

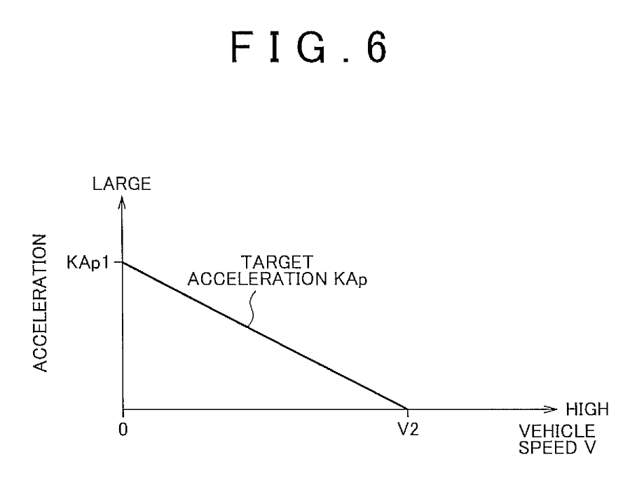

A second modified example of the embodiment will now be described. According to the second modified example, the processing of Step S120 shown in FIG. 3 may be omitted. In this case also, the first, second, fourth, and fifth effects of the above embodiment can be obtained. Next, a third modified example of the embodiment will be described. During setting of the target acceleration KAp, as shown in FIG. 4 of the embodiment, the fixed value KAp1 is set as the target acceleration KAp when the vehicle speed V is no lower than “0” and lower than the first vehicle speed V1. Instead, as shown in FIG. 6, the target acceleration KAp may be set to decrease gradually as the vehicle speed V increases when the vehicle speed V is no lower than “0” and lower than the second vehicle speed V2. In this case also, the fourth effect of the above embodiment can be obtained.

A fourth modified example of the embodiment will now be described. In the above embodiment, an accelerator operation is performed by depressing the accelerator pedal 2. Instead, an accelerator operation may be performed by an operation other than pedal depression. An operation using a hand, such as a paddle shift, a voice operation, and so on may be cited as examples of accelerator operations other than pedal depression.

A fifth modified example of the embodiment will now be described. In the above embodiment, a case in which the driving force control apparatus according to the invention is applied to a vehicle including the engine 6 as a prime mover was described. According to the fifth modified example, the driving force control apparatus according to the invention may be applied similarly to an electric automobile including a motor as a prime mover, a hybrid automobile including both a motor and an engine as prime movers, and so on.

In the embodiments of the invention, S130 to S150 in FIG. 4 may be considered as a driving force suppression processing unit and a control unit of the invention. Further, S100 and S120 may be considered as an execution condition determination unit of the invention. Furthermore, S110 may be considered as a target acceleration calculation unit of the invention. Note, however, that the embodiments of the invention are not limited thereto.

What is claimed is:

1. A driving force control apparatus for a vehicle, comprising:
a driving force suppression processing unit that executes driving force suppression processing to set a driving force output from a prime mover below a driving force corresponding to an accelerator operation amount; and
a control unit that modifies a driving force output during execution of the driving force suppression processing in accordance with a steering angle of the vehicle.

2. The driving force control apparatus according to claim 1, wherein the driving force suppression processing unit reduces the driving force output during execution of the driving force suppression processing as the steering angle increases.

3. The driving force control apparatus according to claim 1, further comprising an execution condition determination unit that executes the driving force suppression processing when the accelerator operation amount satisfies a predetermined condition and an acceleration of the vehicle equals or exceeds a predetermined determination value.

4. The driving force control apparatus according to claim 1, wherein the driving force suppression processing unit controls the driving force during execution of the driving force suppression processing such that an acceleration of the vehicle decreases as a vehicle speed increases.

5. The driving force control apparatus according to claim 1, further comprising a target acceleration calculation unit that calculates a target acceleration of the vehicle and calculates a target driving force to be output during execution of the driving force suppression processing on the basis of a deviation between the target acceleration and an actual acceleration of the vehicle.

6. The driving force control apparatus according to claim 5, wherein:
the target acceleration calculation unit calculates the target acceleration on the basis of a vehicle speed; and
the control unit calculates a decelerating acceleration that decelerates the vehicle on the basis of the steering angle and modifies the target driving force by setting the target acceleration at a value obtained by subtracting the decelerating acceleration from the target acceleration.

7. A driving force control method for a vehicle, comprising:
executing driving force suppression processing to set a driving force output from a prime mover below a driving force corresponding to an accelerator operation amount; and
modifying a driving force output during execution of the driving force suppression processing in accordance with a steering angle of the vehicle.

8. The driving force control method according to claim 7, wherein the driving force output during execution of the driving force suppression processing is reduced as the steering angle increases.

9. The driving force control method according to claim 7, further comprising determining whether or not the accelerator operation amount satisfies a predetermined condition and an acceleration of the vehicle equals or exceeds a predetermined determination value as an execution condition for the driving force suppression processing.

10. The driving force control method according to claim 7, wherein, during execution of the driving force suppression processing, the driving force is controlled such that an acceleration of the vehicle decreases as a vehicle speed increases.

11. The driving force control method according to claim 7, further comprising calculating a target acceleration of the vehicle, and calculating a target driving force to be output during execution of the driving force suppression processing on the basis of a deviation between the target acceleration and an actual acceleration of the vehicle.

12. The driving force control method according to claim 11, wherein:
the target acceleration is calculated on the basis of a vehicle speed; and
a decelerating acceleration that decelerates the vehicle is calculated on the basis of the steering angle, whereupon the target driving force is modified by setting the target acceleration at a value obtained by subtracting the decelerating acceleration from the target acceleration.
